(19) United States
(12) Patent Application Publication
(10) Pub. No.: US 2015/0202693 A1
(43) Pub. Date: Jul. 23, 2015

(54) CLAMPING DEVICE FOR CLAMPING CYLINDRICAL OBJECTS

(71) Applicant: VERTEX MACHINERY WORKS CO., LTD., TAICHUNG CITY 420 (TW)

(72) Inventor: HAN NUNG HUANG, TAICHUNG CITY 420 (TW)

(73) Assignee: VERTEX MACHINERY WORKS CO., LTD., TAICHUNG CITY 420 (TW)

(21) Appl. No.: 14/251,755

(22) Filed: Apr. 14, 2014

(30) Foreign Application Priority Data
Jan. 22, 2014 (TW) 103201272

(51) Int. Cl. B23B 31/20

(52) U.S. Cl. CPC B23B 31/20; B23B 2231/2008

(57) ABSTRACT

A clamping device for clamping different sizes of cylindrical objects includes a body having a path defined centrally therethrough. The body has a polygonal section which has multiple corners at equal intervals. A clamping portion having outer threads is connected to one end of the polygonal section and a locking collar is threadedly connected to the clamping portion. The clamping portion clamps an object. The body has a room defined therein and the room has a tapered inside so as to accommodate a clamping sleeve which has a clamping hole and a tapered outside which is engaged with the tapered inside of the room. The clamping collar controls the size of the clamping hole of the clamping sleeve to proceed vertical or horizontal machining. The clamping sleeve releases the object by loosing the locking collar.

### BACKGROUND OF THE INVENTION

1. Fields of the Invention

The present invention relates to a clamping device, and more particularly, to a clamping device for clamping different sizes of cylindrical objects to be machined.

2. Descriptions of Related Art

The conventional clamping device is designed to clamp metal objects to be machined such as cutting, milling and drilling. For some objects such as the flange on a shaft, usually is required to be drilled at equal intervals. An indexing unit such as disclosed in Taiwan utility Model No. M333965 is required to allow the drilling machine to drill the holes at equal intervals. However, the indexing unit includes multiple parts and has a complicate structure. The conventional indexing unit is expensive.

An indexing unit 9 as shown in FIG. 9 is disclosed in Taiwan Patent Publication No. 78207614 and comprises a base, a shaft, a set of roller bearings, a locking nut, a sleeve, a locking collar, an indexing sleeve, a tightening collar, a socket reception member, a resilient tubular clamp and a tubular clamp locking nut. The invention controls the size of the opening of the resilient tubular clamp by using a control rod so that the object can be quickly clamped and removed. The indexing pin unit is cooperated with the notches defined in the outside of the indexing sleeve to have a precision cutting. The roller bearings are benefit for heavy cutting. The replacement of the resilient tubular clamp is easy by loosing the tubular clamp locking nut.

However, the indexing unit 9 comprises many parts and is expensive. When in use, the users have to count the number of notches that the indexing sleeve passes, and this can be wrong if the users do not concentrate or feel tired such that the result of machining is wrong and incorrect. The object has to be discarded if the holes are drilled at incorrect positions.

The present invention intends to provide a clamping device for clamping different sizes of cylindrical objects to be machined. The clamping device includes less number of parts and is operated easily to prevent the users from incorrectly machining the objects.

### SUMMARY OF THE INVENTION

The present invention relates to a clamping device for clamping different sizes of cylindrical objects comprises a body which is a multiple-stage member and has a path defined centrally therethrough. The body has a polygonal section which has multiple corners at equal intervals. The path has inner threads defined in the inside of one end thereof. A clamping portion is connected to one end of the polygonal section so as to clamp an object. A standard end piece has outer threads which are connected to the inner threads in the path of the body. The object is clamped by the clamping portion and is machined at equal intervals.

Preferably, the polygonal section has even number of corners which have at least four corners.

Preferably, the clamping portion has a flange connected to the end of the polygonal section. A locking portion is connected to one end of the flange and has outer threads defined in the outside thereof. The body has a room defined therein, and the room has a tapered inside. A clamping sleeve is located in the room to clamp cylindrical objects of different sizes. A locking collar has inner threads which are connected to the locking portion of the body.

Preferably, the standard end piece has different lengths.

The primary object of the present invention is to provide a clamping device for clamping different sizes of cylindrical objects to be machined, the clamping device has a simple structure and is less expensive. The clamping sleeve and the standard end piece may have different sizes to clamp different sizes of cylindrical object to be machined at equal intervals. The machining depth of the object can be controlled. The present invention is suitable for machining the objects in one task in a mass scale.

The number of the corners of the polygonal section of the body of the present invention can be any equal number such as four, six or eight. The users can easily understand and use the polygonal section to proceed the machining actions at equal intervals so as to prevent wrong action being taken.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the clamping device of the present invention;

FIG. 2 is an exploded view of the clamping device of the present invention;

FIG. 3 is a cross sectional view of the clamping device of the present invention;

FIG. 4 is a perspective view to show the second embodiment of the clamping device of the present invention;

FIG. 5 is an exploded view of the second embodiment of the clamping device of the present invention;

FIG. 6 shows that the first embodiment of the clamping device of the present invention is used with a vise;

FIG. 7 shows that the third embodiment of the clamping device of the present invention clamps an object;

FIG. 8 shows that the fourth embodiment of the clamping device of the present invention, and

FIG. 9 shows the conventional clamping device.

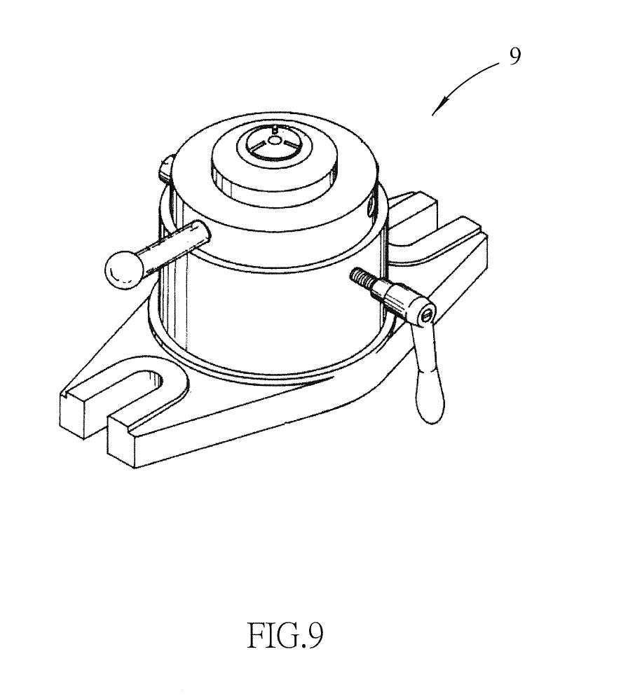

### DETAILED DESCRIPTION OF THE PREFERRED EMBODIMENT

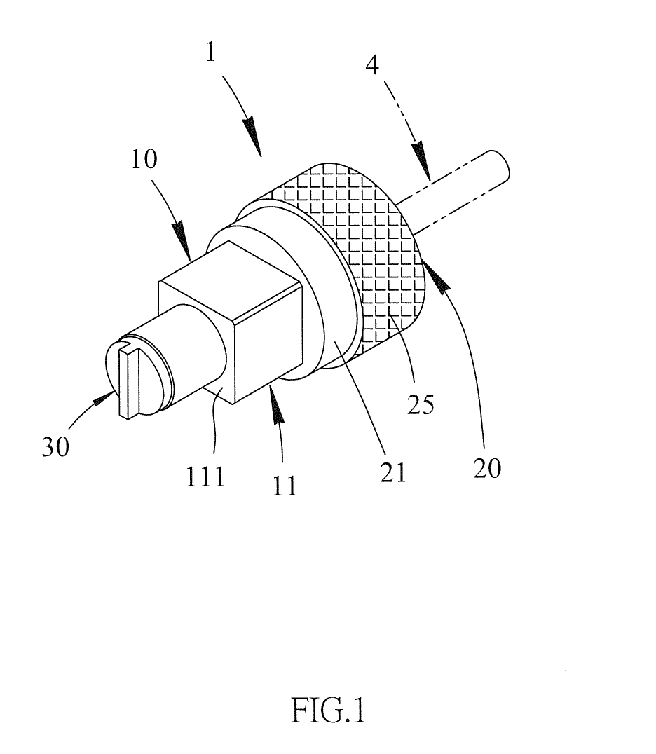

Referring to FIGS. 1 to 3, the first embodiment 1 of the clamping device of the present invention comprises a body 10, a clamping portion 20, and a standard end piece 30.

The body 10 is a multiple-stage member and has a polygonal section 11 which has multiple corners at equal intervals. A path 101 is defined centrally through the body 10 and has inner threads 102 defined in the inside of one end thereof.

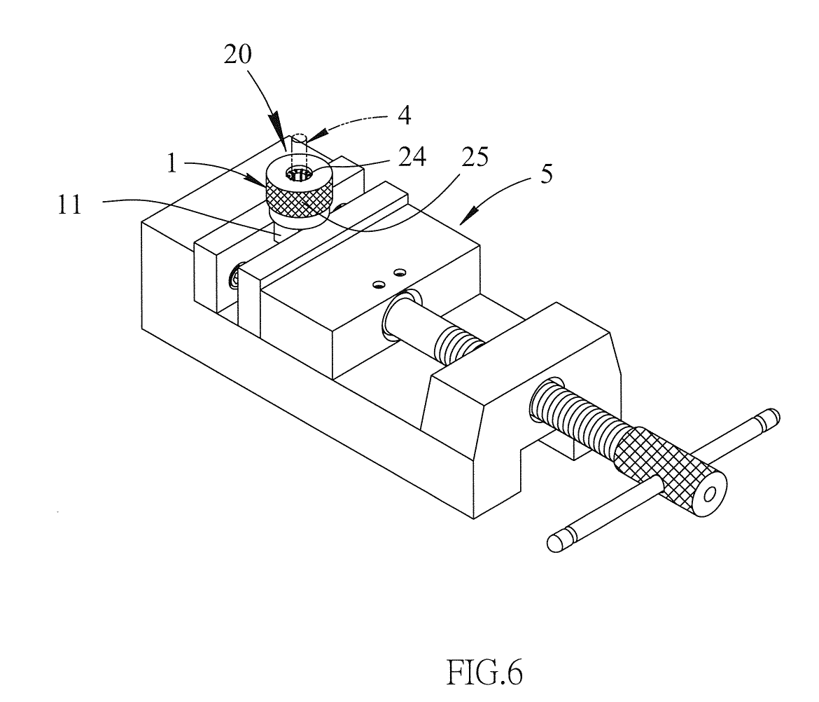

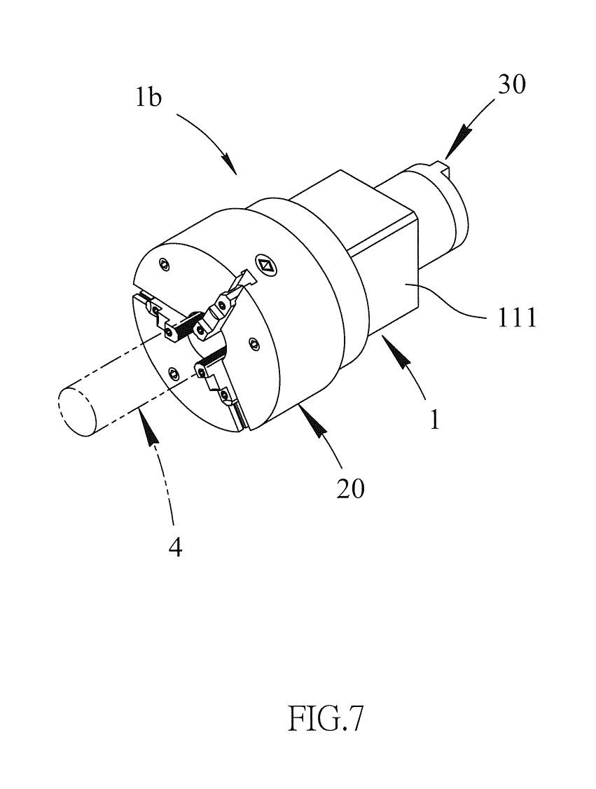

A flange 21 is connected to one end of the polygonal section 11 and a locking portion 22 is connected to one end of the flange 21. The locking portion 22 has outer threads 221 defined in the outside thereof. The body 10 has a room 12 defined therein, the room 12 has a tapered inside 121. The polygonal section 11 has even number of corners which may have four corners 111 or six corners 111 a so as to increase the use of equal-interval machining as shown in FIGS. 6 and 7. The equal-interval machining includes drilling holes and notches, or machining on outside of the objects.

The clamping portion 20 includes a clamping sleeve 24 which is an integral sleeve with multiple slits 241 continuously defined through the wall thereof. The clamping sleeve 24 has a clamping hole 242 and a tapered outside 243. The clamping sleeve 24 is located in the room 12 and the tapered outside 243 is engaged with the tapered inside 121 in the room 12. The clamping hole 242 reduces to clamp an object 4 due to gravity and the force applied to the tapered outside 243. When no force is applied to the tapered outside 243, the clamping hole 242 bounces back to its initial size due to the flexibility of the clamping sleeve 24. It is noted that clamping sleeve 24 is made to be able to clamp different standard sizes of end milling cutters. In this embodiment, the clamping sleeve 24 is designed to clamp objects 4. The clamping sleeve 24 can quickly clamp and release the objects so that the present invention provides convenient operational advantages to the users. A locking collar 25 has inner threads 252 which are connected to the locking portion 22 of the body 10. The locking collar 25 has a knurled surface 253 defined in the outside thereof so that the user can easily grasp the locking collar 25.

The standard end piece 30 has outer threads 301 which are connected to the inner threads 102 in the path 101 of the body 10. One end in the body 10 of the object 4 contacts the standard end piece 30 so as to set the depth of machining. The standard end piece 30 may have different lengths so as to provide different depths of machining.

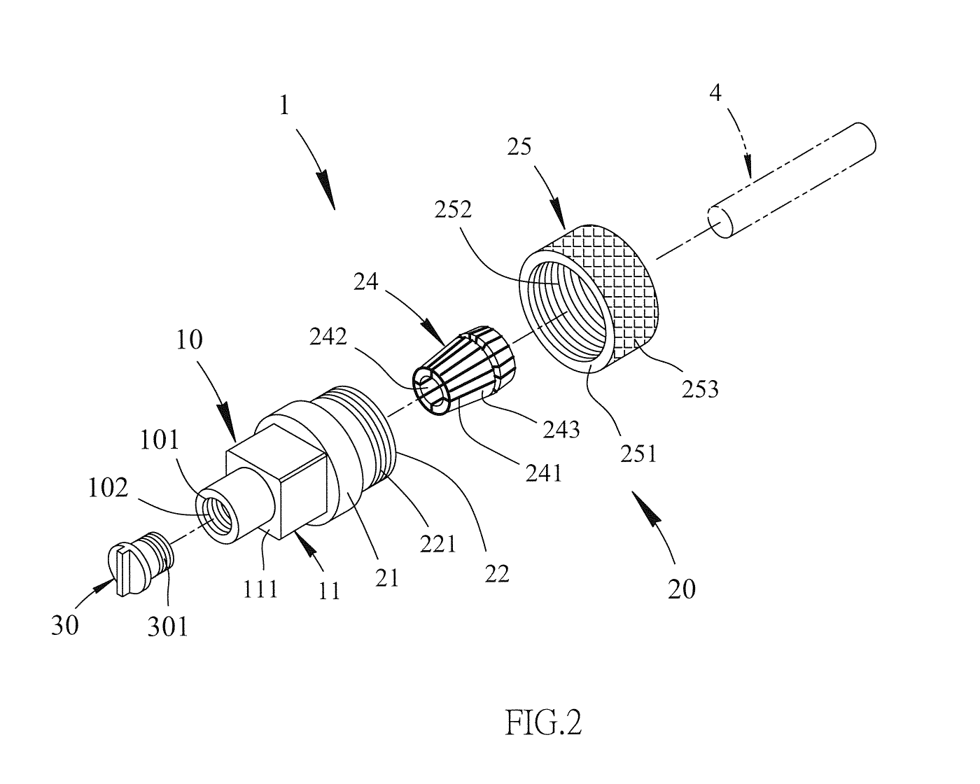

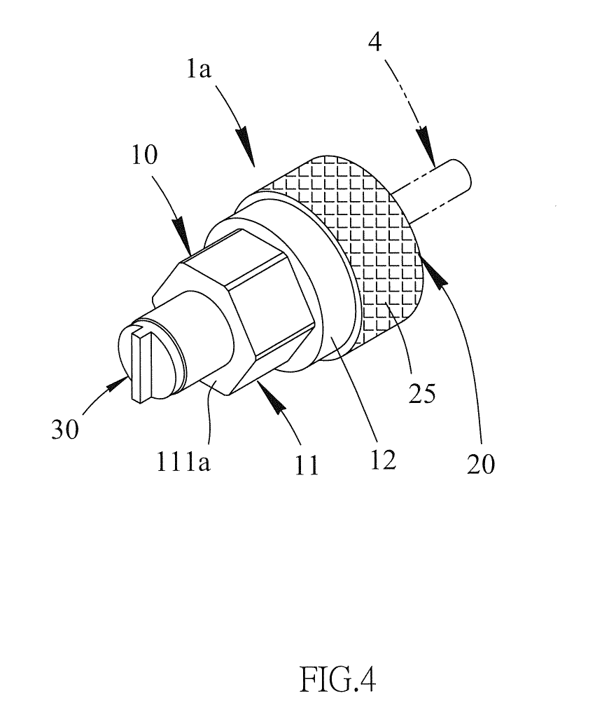

As shown in FIGS. 2 to 4, in the first embodiment 1 or second embodiment 1a of the present invention, the clamping sleeve 24 is located in the room 12, and inner threads 252 of the locking collar 25 are connected to the outer threads 221 of the body 10 to let the locking collar 25 contact the flange 21. The end face 251 of the locking collar 25 pushes the end face of the clamping sleeve 24 so that the clamping sleeve 24 moves into the room 12. The tapered outside 243 is tightly matched with the tapered inside 121 so that the clamping hole 242 of the clamping sleeve 24 is reduced to clamp the object 4.

When the object 4 in the first embodiment 1 is to be removed, the locking collar 25 is loosened so that the tapered outside 243 is released from the tapered inside 121 of the body 10. The clamping hole 242 of the clamping sleeve 24 bounces back to its initial size due to the flexibility of the clamping sleeve 24 such that the object 4 can be removed from the clamping sleeve 24.

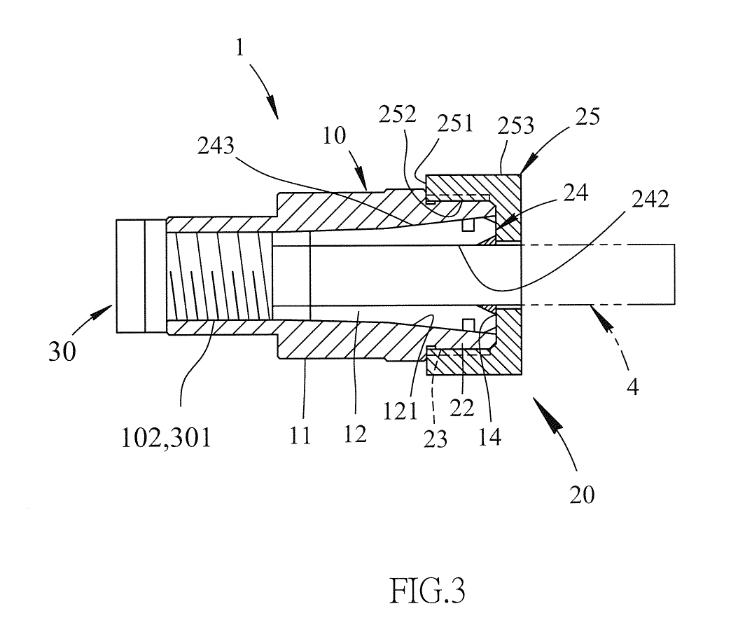

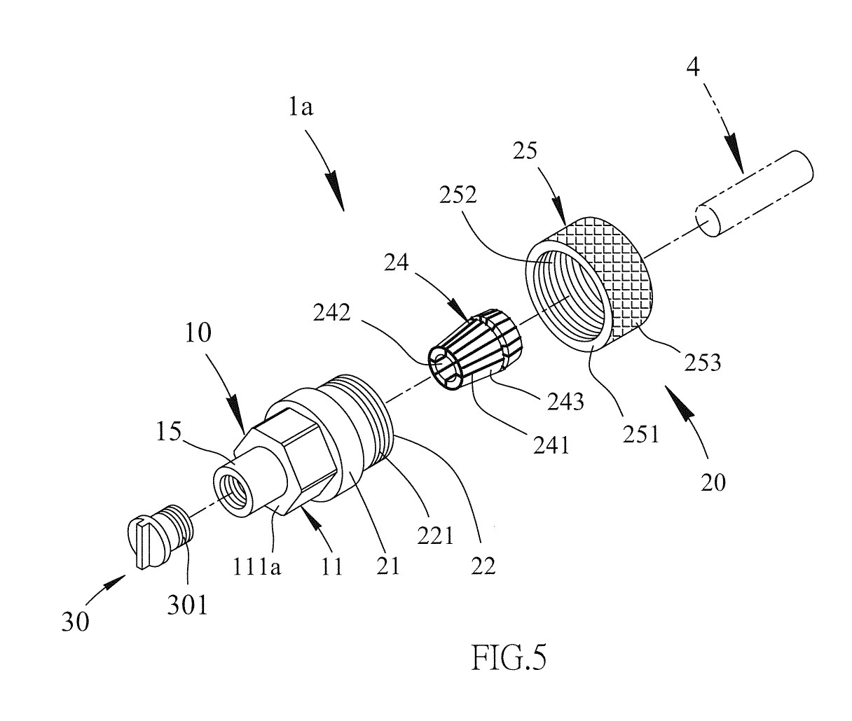

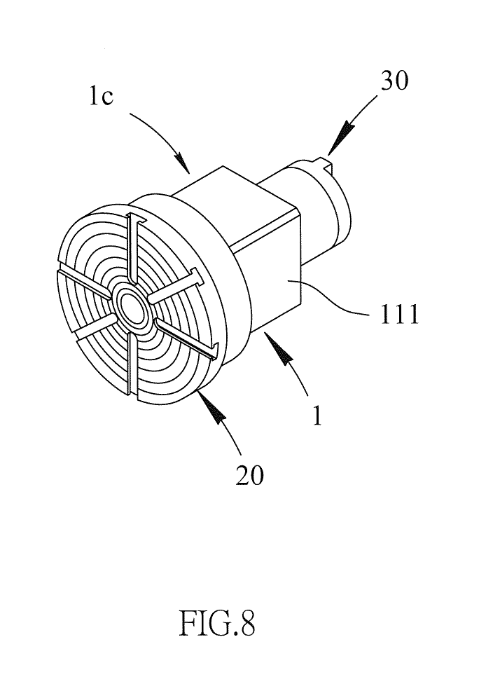

As shown in FIGS. 3 to 6, the difference between the first embodiment 1 and the second embodiment 1a is that the shape of the polygonal section 11 and the function of the polygonal section 11. The polygonal section 11 of the first embodiment 1 has four corners 111 as shown in FIG. 1 so that when the clamping device is used with a vise, the object can be machined four equal intervals. As shown in FIG. 6, the polygonal section 11 of the second embodiment 1a has six corners 111a so that when the clamping device is used with a vise, the object can be machined six equal intervals. As shown in FIG. 7 which shows the third embodiment 1b of the present invention, wherein the clamping portion 20 have multiple claws which clamp a cylindrical object 4. The clamping portion 20 can also be clamping disk or any known clamping unit to clamp uneven object as shown in the fourth embodiment 1c in FIG. 8.

While we have shown and described the embodiment in accordance with the present invention, it should be clear to those skilled in the art that further embodiments may be made without departing from the scope of the present invention.

What is claimed is:

1. A clamping device for clamping different sizes of cylindrical objects, comprising:
a body being a multiple-stage member and having a path defined centrally therethrough, the body having a polygonal section which has multiple corners at equal intervals, the path having inner threads defined in an inside of one end thereof;
a clamping portion connected to an end of the polygonal section, the clamping portion adapted to clamp an object, and
a standard end piece having outer threads which are connected to the inner threads in the path of the body.

2. The device as claimed in claim 1, wherein the polygonal section has even number of corners which have at least four corners.

3. The device as claimed in claim 1, wherein the clamping portion has a flange connected to the end of the polygonal section, a locking portion is connected to an end of the flange and has outer threads defined in an outside thereof, the body has a room defined therein, the room has a tapered inside, a clamping sleeve is located in the room and adapted to clamp cylindrical objects of different sizes, a locking collar has inner threads which are connected to the locking portion of the body.

4. The device as claimed in claim 3, wherein the standard end piece has different lengths.
